(19) United States
(12) Patent Application Publication
(10) Pub. No.: US 2007/0278961 A1
(43) Pub. Date: Dec. 6, 2007

(54) Circuit Arrangement for Degaussing a Picture Tube, and Respective Picture Display Device

(76) Inventors: Jean-Paul Louvel, Brigachtal (DE); Peter Halupczok, Villingen-Schwenningen (DE)

Correspondence Address: JOSEPH J. LAKS, VICE PRESIDENT;THOMSON LICENSING LLC, PATENT OPERATIONS, PO BOX 5312, PRINCETON, NJ, 08543-5312, US

(21) Appl. No.: 10/586,629

(22) PCT Filed: Jan. 26, 2005
(86) PCT No.: PCT/EP05/00739

§ 371 Date: May 9, 2007

(30) Foreign Application Priority Data
Jan. 27, 2004 (DE) 102004004216.0

(51) Int. Cl. H04N 9/29

(52) U.S. Cl. 315/8

(57) ABSTRACT

The circuit arrangement for degaussing a picture tube comprises a degaussing coil (ES), a single PTC element (T) and a switch (R), the degaussing coil (ES), the single PTC element (T) and the switch (R) being connected in series For a degaussing, the degaussing coil (ES) is activated by means of the switch (R) for a defined time interval such that the switch-off takes place at an ampere-turns product of greater than 5.

### FIELD OF THE INVENTION

The present invention is based on a circuit arrangement having a PTC thermistor and a degaussing coil for degaussing a picture tube. Circuits of this type are used in cathode ray picture display devices, for example television sets and computer monitors.

### BACKGROUND

In the case of a CRT type television set, a degaussing coil in looped form is arranged on the upper half and on the lower half of the picture tube, by means of which magnetic parts within the picture tube and in its vicinity are demagnetized. For this purpose, the degaussing coil is operated with an AC current which initially has a high current value and then gradually decreases. The decrease is in this case brought about by a PTC thermistor that is connected in series with the degaussing coil and is heated by the current. Since the resistance of a PTC thermistor rises as it is heated, this brings about a desired decrease in the current. Corresponding thermistors and a current profile for degaussing a picture tube are disclosed for example in U.S. Pat. No. 4,504,817.

Present-day circuit arrangements for degaussing a picture tube use a double PTC thermistor, one PTC element being connected in series with the degaussing coil and the second element being connected in parallel with the mains. In this case, the first PTC element brings about the desired current decrease after the degaussing current has been switched on, and the second PTC element heats the first PTC element during operation of the television set, so that the current through the degaussing coil is kept low after degaussing.

Furthermore, a circuit arrangement of this type must comply with certain safety specifications. In the case of a short circuit in the PTC thermistor, in particular the degaussing coil must not be heated excessively. This is brought about for example by intentional triggering of the mains fuse in the case of a fault and thus by the resistance of the degaussing coil. Since a triggering of the mains fuse has to be avoided in the operating case, a resistance ratio of degaussing coil to the PTC thermistor of approximately 1/1 results here. The total resistance of degaussing coil plus PTC thermistor determines the size of the mains fuse in this case.

The resistances of the degaussing coil and the PTC thermistor are therefore balanced such, that in the case of a short circuit of the PTC thermistor, the fuse of a corresponding television set being arranged on the mains input side must trigger in such a way as to avoid an overheating of the degaussing coil. In order to obtain a sufficiently high magnetic field when the degaussing coil is switched on, the degaussing coil must have a high number of turns in order to achieve the required ampere-turns product in the case of this series resistance. During operation, the double PTC element ensures that the ampere-turns product is sufficiently low such that no picture disturbances are caused by the residual magnetic field of the degaussing coil.

An ampere-turns product with a value of 2000 at the start of the degaussing phase suffices to bring about effective degaussing. The current must then gradually decrease in such a way that at least 50% of the initial amplitude is still present after five cycles. The ampere-turns product is furthermore required to be a maximum of one, measured from peak to peak, at the end of the degaussing phase. Picture disturbances due to the magnetic field of the degaussing coil during operation of the television set are negligible as a result of this.

In order to fulfill all the necessary requirements the series resistance cannot be decreased arbitrarily, and the resistance ratio of PTC element to degaussing coil likewise leads to a relatively large copper cross section of the degaussing coil since the latter must be of comparatively low resistance given a relatively high number of turns in order to achieve the desired resistance. This results in relatively heavy degaussing coils made of copper, for example with a weight of 350 grams in the case of a 29 inch picture tube and with a weight of approximately 920 grams in the case of a 34 inch picture tube.

DE-A-10217951 discloses a circuit arrangement for degaussing a picture tube. In this case, the circuit arrangement is switched on and off by means of a mains switch, so that a degaussing of the picture tube takes place in each case when the corresponding device is switched on.

Demagnetizing arrangements comprising a relay, respectively a transistor switch, are known from DE-A-19611955, U.S. Pat. No. 5,696,565 and DE-A-3824038. DE-A-19855457 describes a circuit arrangement of this kind, which comprises further a frequency converter for demagnetizing a picture tube with a higher frequency.

### SUMMARY OF THE INVENTION

The object of the present invention is to specify an improved circuit arrangement and a respective picture display device of the types mentioned above, which are in particular more cost-effective.

This object is achieved by means of a circuit arrangement having the features of claim 1 and by a picture display device with the features of claim 8. Advantageous developments of the invention are specified in the subclaims.

According to the invention, the circuit arrangement for degaussing a picture tube is switched on by means of a switch only for a very short time, for example 3 seconds. The invention is useful in particular for television sets with an aspect ratio of 16:9, and a degaussing may be provided in the event of a switch on or in the event of a changeover from the standby mode to the normal mode.

The requirements made of the circuit arrangement for degaussing a picture tube become less restrictive as a result of this: for present-day picture tubes, it suffices if the ampere-turns product is 20 to 30 at the end of the magnetization cycle, providing a satisfactory demagnetization of the materials as a result of this. This value has been proven by cathode ray tube manufacturers. The current is subsequently reduced to zero by means of the switch, which avoids any picture disturbances due to the degaussing coil during operation. The safety problem in the case of a short circuit is likewise solved here since the degaussing coil is not heated to a dangerous temperature value in the short time of just a few seconds, in case of a broken PTC element. In particular, a mains fuse arranged upstream of the circuit arrangement does not have to trigger anymore in case of a short of the PTC element.

At the same time, the requirements for the PTC thermistor are reduced as a result of this, so that a single PTC element can be used instead of a double PTC element. It is now possible to use an inexpensive PTC thermistor having, by way of example, a significantly lower resistance of nine, five, or four ohms, instead of an 18 ohm double PTC thermistor. The resistance ratio of degaussing coil to PTC thermistor of approximately one to one is now no longer relevant since the safety problem in the case of a short circuit, as a result of the current being switched off after degaussing, no longer exists.

As a result of this, the requirements made of the overall circuit become less stringent, so that the wire diameter and the number of turns can be reduced, but still providing an ampere-turns product of 2000 at the switch-on instant and a desired current decrease with a degaussing coil now, in which the copper weight is reduced by approximately half. With a single PTC thermistor, the ampere-turns product then decreases within a few seconds to a value of 20 to 30, and subsequently to zero as a result of the switch-off. The switching-on and -off of the switch may be effected in terms of hardware by means of a timer circuit, by way of example, or may be controlled by means of software using a microprocessor of a corresponding device.

The additional costs of the switch, for example of a relay, are thereby already compensated for even in the case of 16:9 picture tubes having a diagonal of 28 inches. According to a first calculation, the cost saving amounts to approximately 0.4 to 0.5 euro in the case of a 28 inch picture tube and up to 3 or 4 euro in the case of 37 inch picture tubes. Instead of a smaller degaussing coil made of copper, it is now also possible in particular to use a degaussing coil with aluminum wires, which leads to an additional cost saving. Since the degaussing coil is now switched off in the standby mode via the switch, this furthermore results in a power saving of approximately 1.2 watts for the standby mode.

The exemplary embodiments described above relate to a mains voltage of 230 volts. Similar possibilities for savings are afforded in the case of a mains voltage of 110 volts since, at 110 volts, a degaussing coil according to the prior art has to be of even lower resistance than in the case of a mains voltage of 230 volts.

### BRIEF DESCRIPTION OF THE DRAWINGS

Preferred embodiments of the invention are explained in more detail below by way of example with reference to schematic drawings showing:

FIG. 1 a circuit arrangement having a degaussing coil, a switch and a single PTC element for degaussing a picture tube, and

FIG. 2 a measured current waveform from a circuit arrangement as shown in FIG. 1.

### DETAILED DESCRIPTION OF PREFERRED EMBODIMENTS

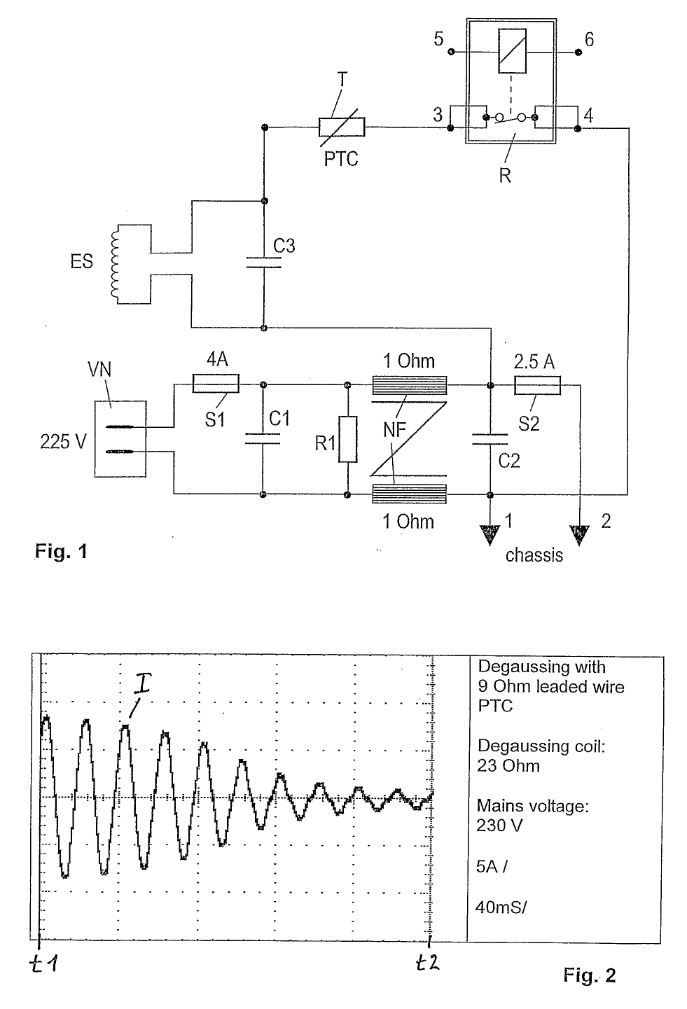

The FIG. 1 illustrates a circuit arrangement for degaussing a picture tube of a picture display device, for example of a television set or of a computer monitor. The device is connected to the mains voltage, for example an AC voltage of 225 volts, via a mains terminal VN. Connected downstream of the mains terminal VN is a mains filter NF which, together with two capacitors C1, C2 and a resistor R1, suppresses interfering voltages present in the mains voltage.

Situated downstream of the mains filter NF are two terminals 1 and 2, which are connected to the chassis of the picture display device, for example to the input side of a switch mode power supply. A mains fuse S1 is arranged upstream of the mains filter MF and a second fuse S2 is arranged ahead of the terminal 2 for a protection of the chassis. Chassis of television sets and computer monitors are sufficiently known and are not the subject-matter of this invention; therefore, they are not explained any further here.

A series circuit with a degaussing coil ES, a thermistor element T and switching contacts 3 and 4 of a switch R, a relay in this embodiment, is connected to the output side of the mains filter NF, in parallel with the capacitor C2. The thermistor element T is in particular a single PTC element. The relay R furthermore has control contacts 5 and 6 for a control of the relay R, by means of which a voltage present at the switching contacts 3 and 4 is switched through or blocked. The relay R provides advantageously a mains separation between contacts 3, 4 and contacts 5, 6.

The circuit arrangement is switched on only for a short time by means of the switch for the purpose of degaussing the picture tube. In this case, the time interval is chosen to be sufficiently short in order to avoid an overheating of the degaussing coil ES in the case of a short circuit in the single PTC element T. The time interval has, by way of example, a time value of 1 to 20 seconds, in particular of 2 to 5 seconds, and does not lead to an over-heating of the degaussing coil ES in case of a short of the PTC element T. The mains fuse S1 arranged upstream of the circuit arrangement therefore does not have to trigger anymore in case of a short of the PTC element T.

If a microprocessor of the device is used for controlling the degaussing circuit, then when a television set is switched on, by way of example, degaussing is carried out if the microprocessor is ready for operation. Preferably, the degaussing circuit is also switched on for a short time interval when changing over from the standby mode to the normal mode.

The relay R and the thermistor element T are preferably arranged on the chassis of a respective device. A capacitor C3 arranged with respect to the degaussing coil ES is likewise arranged on the chassis and prevents voltages of the deflection coils that are induced in the degaussing coil ES from propagating further by virtue of the fact that the latter are short-circuited by the capacitor C3. The degaussing coil ES is arranged around the rear part of the picture tube of the device in a known manner.

In a preferred embodiment, the circuit arrangement for degaussing a picture tube contains a 9 Ohm single PTC thermistor element, a degaussing coil with e resistance of 23 Ohm and a relay R, which has a mains isolation between the switching contacts 3 and 4 and the control contacts 5 and 6. The control contacts 5 and 6 are coupled to a microprocessor, for example the main microprocessor of a television set. Between the control contacts 5 and 6 and the microprocessor there may be arranged a driver stage for operating the relay. Therefore, by virtue of the mains isolation, the relay R can be actuated directly by the microprocessor.

In FIG. 2 a current waveform as a function of time v showing a degaussing current I is displayed for a preferred embodiment in accordance with FIG. 1. The applied mains voltage is 230 volts, which is immediately present across the degaussing coil at a time t1 after switching-on the respective picture display device. The resistance of the degaussing coil 23 ohm. The frequency of the alternating current corresponds to the mains frequency of 50 Hz. Because of the heating of a 9 ohm leaded wire PTC element, the current I is degreasing over time. At a time t2 of 240 milliseconds, the current through the degaussing coil is decreased already to a small fraction, and at a later time of 3 seconds, not shown, the current is switched off by the relay. The scales of the diagram, FIG. 2 are: 5 ampere per centimeter and 40 milliseconds per centimeter for the time base.

In contrast, for a picture tube of this kind a double PTC element with 18 ohms and a degaussing coil of 18 ohms has been used in the past, for providing a resistance ratio of 1:1 between coil and PTC element. The reduced cost for the PTC single element and the degaussing coil compensates therefore for the additional cost of the relay and provides cost savings in particular for picture tubes of 28 inch and larger.

For a person skilled in the art, further applications of the invention are within the scope of his customary activity. The circuit arrangement according to the invention may, in particular, be used in all devices that use a cathode ray tube for a picture display. The circuit arrangement is independent of a power supply unit used and may, in particular, also be used in devices which have a power factor correction.

1. A circuit arrangement for degaussing a picture tube comprising
a degaussing coil,
a single PTC element, and
a switch,
said degaussing coils, said single PTC element and said switch being arranged in series for providing a degaussing by activation of said switch for a defined time interval.

2. The circuit arrangement as claimed in claim 1, wherein the time interval is chosen such that the switch-off takes place at an ampere-turns product of greater than 5, in particular at an ampere-turns product within the range of 20 to 30.

3. The circuit arrangement as claimed in claim 1, wherein the time interval has a value of 1 to 20 seconds, in particular of 2 to 5 seconds, for avoiding an overheating of the degaussing coil in the case of a short circuit in said single PTC element.

4. The circuit arrangement as claimed in claim 1, wherein said switch is a relay having a mains isolation, the control contacts of said relay being coupled to a microprocessor for control by the microprocessor.

5. The circuit arrangement as claimed in claim 1, wherein said degaussing coil is made of an aluminum winding having a resistance of 15 to 30 ohms.

6. The circuit arrangement as claimed in claim 1, wherein said degaussing coils, in the case of a mains voltage of 220 to 240 volts, has a weight of less than 250 grams in the case of 28 and 29 inch picture tubes, a weight of less than 300 grams in the case of 32 and 34 inch picture tubes, and a weight of less than 500 grams in the case of 37 inch picture tubes.

7. The circuit arrangement as claimed in claim 1, wherein said single PTC element has a resistance of less than 12 ohms, in particular less than or equal to 9 ohms.

8. A picture display device with a cathode ray tube, comprising a circuit arrangement as claimed in claim 1.

9. The picture display device as claimed in claim 8, comprising further a microprocessor being coupled to a control terminal of said relay via a driver stage for operation of said degaussing circuit, for a degaussing is in each case effected when said picture display device is switched on by said microprocessor by means of said degaussing circuit.
